(19) United States
(12) Patent Application Publication
(10) Pub. No.: US 2015/0082222 A1
(43) Pub. Date: Mar. 19, 2015

(54) INFORMATION PROCESSING PROGRAM PRODUCT, INFORMATION PROCESSING APPARATUS, AND INFORMATION PROCESSING SYSTEM

(71) Applicant: Tsuyoshi YAMADA, Kanagawa (JP)

(72) Inventor: Tsuyoshi YAMADA, Kanagawa (JP)

(73) Assignee: RICOH COMPANY, LTD., Tokyo (JP)

(21) Appl. No.: 14/479,477

(22) Filed: Sep. 8, 2014

(30) Foreign Application Priority Data
Sep. 17, 2013 (JP) 2013-192241
Jul. 29, 2014 (JP) 2014-153608

(51) Int. Cl. G06F 3/0484; G06F 3/0481

(52) U.S. Cl. CPC G06F 3/04847; G06F 3/0481
USPC 715/771

(57) ABSTRACT

An information processing program causes a computer to implement the functions of a receiving unit that receives a screen display instruction, an area information storage unit that stores area information relating to a plurality of areas of the screen, a display information storage unit that stores display information for each of the plurality of areas, a display unit that displays the screen based on the area information stored and the display information, an association information storage unit that stores a display switching instruction in association with corresponding area information of the area information, an acquisition unit that acquires the corresponding area information associated with the display switching instruction based on the association information when the display switching instruction is accepted via the screen displayed by the display unit, and a display control unit that switches the screen based on the corresponding area information acquired by the acquisition unit.

### BACKGROUND OF THE INVENTION

1. Field of the Invention

The present invention relates to a technique for controlling a user interface.

2. Description of the Related Art

To use a driver of a printing device, a user opens a graphical user interface (GUI) to set up print settings so that printing may be executed in a desired manner. The print settings may be set up using conventional controls (GUI components) such as buttons, comboboxes, radio buttons, and icons for enabling the user to check multiple print settings, for example. The controls are accommodated within a certain area (region). From the perspective of the user, the controls are displayed on a screen that accepts setup instructions.

The arrangement of such controls may be customized by an administrator or a general user. In this respect, a technique is known that involves conforming the size of all controls to a fixed size or an integer multiple thereof so that the controls may be seamlessly arranged (see e.g. Japanese Laid-Open Patent Publication No. 2009-169462).

In the conventional method of arranging the controls as described above, controls for each group of settings such as “Custom Settings” and “Detail Settings” are arranged within a confined area where the controls are allowed to be arranged.

Thus, although controls can be freely arranged within the confined area, because the controls are treated equally, arrangement properties cannot be individually assigned to the controls to distinguish between controls that are desirably fixed and controls that may be freely moved, for example. As a result, when controls are added or removed through customization or according to the specification of the printing device, for example, the arrangement of controls may become complicated, and a uniform user interface may not be achieved. Also, with respect to customizing the user interface according to preferences and characteristics of a particular user, changing the arrangement of all controls may not be necessary. That is, enabling partial changes to the arrangement of controls may often bring satisfaction to a variety of users without forcing each individual user to customize the user interface.

Further, when a user performs operations using a GUI, the user is unable to dynamically switch between displaying and not displaying a control arranged within a certain area, for example.

In light of the above, there is a demand for a technique for facilitating the arrangement of controls.

### SUMMARY OF THE INVENTION

According to one embodiment of the present invention, an information processing program product including a computer-readable medium storing a program executable by a computer is provided, the program when executed causing the computer to implement the functions of a receiving unit configured to receive a screen display instruction to display a screen for accepting an instruction, an area information storage unit configured to store area information relating to a plurality of areas of the screen including at least one set of area information for each of the plurality of areas, a display information storage unit configured to store display information associated with each of the plurality of areas, and a display unit configured to display the screen based on the area information stored in the area information storage unit and the display information stored in the display information storage unit. The program further causes the computer to implement the functions of an association information storage unit configured to store a display switching instruction in association with corresponding area information of the area information stored in the area information storage unit, an acquisition unit configured to acquire the corresponding area information associated with the display switching instruction based on the association information when the display switching instruction is accepted via the screen displayed by the display unit, and a display control unit configured to switch display of the screen based on the corresponding area information acquired by the acquisition unit.

According to an aspect of the present invention, the arrangement of controls may be facilitated.

### BRIEF DESCRIPTION OF THE DRAWINGS

FIGS. 1A and 1B illustrate exemplary configurations of an information processing system according to embodiments of the present invention;

FIG. 2 is a block diagram illustrating an exemplary hardware configuration of an information processing apparatus according to an embodiment of the present invention;

FIG. 3 is a block diagram illustrating an exemplary software configuration of the information processing apparatus according to an embodiment of the present invention;

FIGS. 4A and 4B illustrate examples of creating a binary by building a program;

FIGS. 5A and 5B illustrate exemplary manners in which area configuration data and function plate configuration data are held;

FIG. 6 illustrates an example in which area configuration data and function plate configuration data are held in one file;

FIG. 7 illustrates an example of a user interface;

FIG. 8 illustrates exemplary perceptual regions of the user interface;

FIG. 9 illustrates exemplary areas of the user interface;

FIG. 10 illustrates an example in which function plates are added to the user interface;

FIG. 11 illustrates an example in which an area of the user interface is expanded;

FIG. 12 is a table listing items describing an area configuration and a function plate configuration;

FIG. 13 illustrates a specific example of data describing an area configuration and a function plate configuration;

FIG. 14 illustrates another specific example of data describing an area configuration and a function plate configuration;

FIG. 15 illustrates another specific example of data describing an area configuration and a function plate configuration;

FIG. 16 illustrates an example of a language file;

FIG. 17 illustrates an example of an area switching table; FIG. 1B is a sequence chart illustrating an example of process operations executed when a printer driver receives a user interface display request;

FIG. 19 is a flowchart illustrating an example of process operations of a user interface generation display unit;

FIG. 20 is a flowchart illustrating another example of process operations of the user interface generation display unit;

FIG. 21 illustrates an exemplary arrangement of function plates within an area;

FIG. 22 illustrates exemplary data describing the area configuration and the function plate configuration of FIG. 21;

FIG. 23 illustrates a relationship between an area and function plates;

FIG. 24 is a sequence chart illustrating an example of process operations executed in response to a mode change;

FIG. 25 illustrates an example of process operations for switching a user interface using an external file;

FIG. 26 illustrates another example of process operations for switching a user interface using a an external file; and

FIG. 27 illustrates an exemplary system configuration for applying a point and print function.

### DESCRIPTION OF THE PREFERRED EMBODIMENTS

In the following, embodiments of the present invention are described with reference to the accompanying drawings. Note that although a printer driver is described below as an illustrative example, the present invention may be applied to any information processing program that enables a user to manipulate and configure settings through a user interface. Also, although a multifunction peripheral (MFP) is described below as an example of a peripheral device to be controlled, the present invention may be applied to control various other types of peripheral devices as well.

<System Configuration>

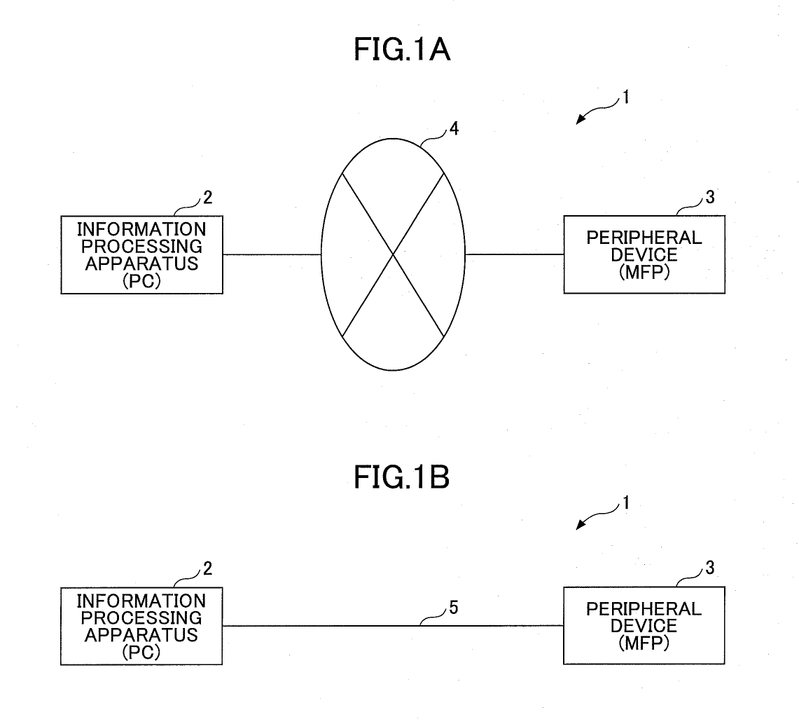

FIGS. 1A and 1B illustrate exemplary configurations of an information processing system 1 according to embodiments of the present invention. The information processing system 1 includes an information processing apparatus 2 such as a PC (personal computer) that is operated by a user and a peripheral device 3 such as a MFP that is to be controlled. As illustrated in FIG. 1A, the information processing apparatus 2 and the peripheral device 3 may be interconnected via a network 4 such as a LAN (local area network) to enable exchange of data with each other. Alternatively, as illustrated in FIG. 1B, the information processing apparatus 2 and the peripheral device 3 may be interconnected via a data transmission line 5 such as a USB (Universal Serial Bus) to enable exchange of data with each other.

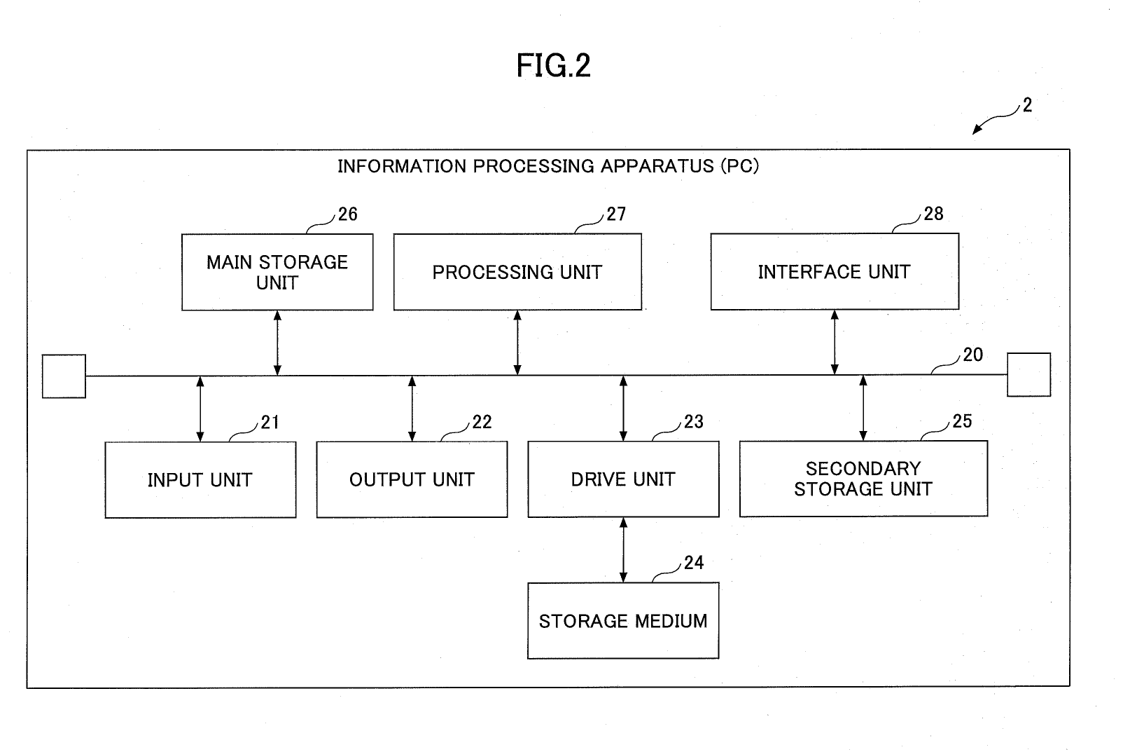

FIG. 2 is a block diagram illustrating an exemplary hardware configuration of the information processing apparatus 2. In FIG. 2, the information processing apparatus 2 includes an input unit 21, an output unit 22, a drive unit 23, a secondary storage unit 25, a main storage unit 26, a processing unit 27, and an interface unit 28 that are interconnected via a bus 20. A storage medium 24 is connected to the drive unit 23.

The input unit 21 may include a keyboard and mouse, for example, and is used to input various signals. The output unit 22 may include a display device, for example, and is used to display various windows and data. The drive unit 23 may be used to write information on the storage medium 24 or read information from the storage medium 24, for example. The storage medium 24 may be any of various types of storage media including a CD-ROM (Compact Disk Read Only Memory), a flexible disk, a magneto-optical disk, a ROM, and a semiconductor memory such as a flash memory, for example.

The secondary storage unit 25 is used to store files and data necessary for processing and may include a hard disk drive, for example. The main storage unit 26 is used as an information processing workspace to temporarily store programs and data. The main memory may include a semiconductor memory, for example. The processing unit 27 is used to perform various types of arithmetic processing and may include a CPU (Central Processing Unit), for example. The interface unit 28 may include a modem, a LAN card, or a USB interface (I/F), for example, and is used to establish connection with the peripheral device 3 via the network 4 or the data transmission line 5.

A printer driver is software for operating the peripheral device 3 from the information processing apparatus 2. The printer driver acts as an interface for enabling an OS (operating system) of the information processing apparatus 2 to control the peripheral device 3. The printer driver may be stored in the storage medium 24 and distributed or downloaded via the network 4, for example.

When the storage medium 24 storing the printer driver is loaded in the drive unit 23, the printer driver may be installed in the secondary storage unit 25 from the storage medium 24 via the drive unit 23. When the printer driver is downloaded from the network 4, the printer driver may be installed in the secondary storage unit 25 via the interface unit 28.

The main storage unit 26 reads the printer driver from the secondary storage unit 25 upon being started and stores the printer driver in the main storage unit 26. The processing unit 27 executes various processes described below according to the printer driver stored in the main storage unit 26.

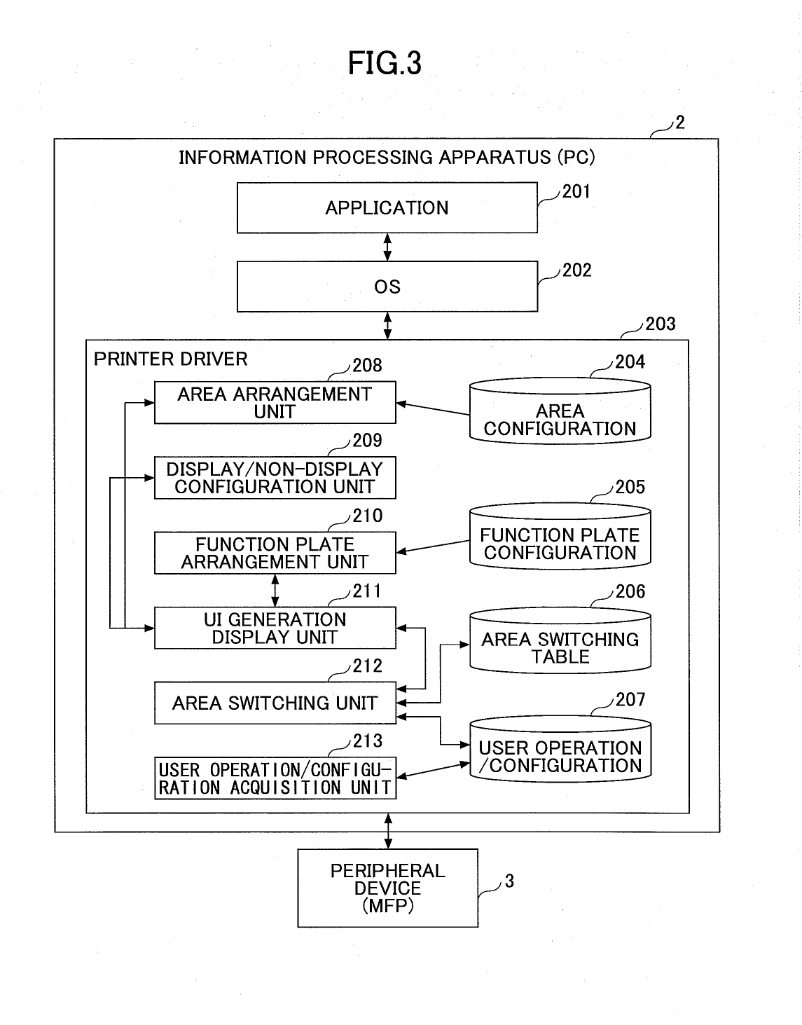

FIG. 3 is a block diagram illustrating an exemplary software configuration of the information processing apparatus 2. In FIG. 3, the information processing apparatus 2 includes an application 201, an OS 202, and a printer driver 203. When the OS 202 receives a request directed to the peripheral device 3 from the application 201, the OS 202 controls the peripheral device 3 via the printer driver 203.

The printer driver 203 includes an area configuration 204, a function plate configuration 205, an area switching table 206, and a user operation/configuration 207 as data to be used for processing. Also, the printer driver 203 includes an area arrangement unit 208, a display/non-display configuration unit 209, a function plate arrangement unit 210, a UI generation display unit 211, an area switching unit 212, and a user operation/configuration acquisition unit 213 as functional units. Note that in FIG. 3, an illustration of the original function of the printer driver relating to transmitting and receiving data for controlling the peripheral device 3 is omitted.

The area configuration 204 describes (defines) the arrangement of areas in which function plates corresponding to various types of controls are arranged. Note that the area configuration 204 may be written as a separate section within the same file as the function plate configuration 205, or the area configuration 204 may be provided as a separate file.

The function plate configuration 205 describes (defines) the arrangement of the function plates within the areas. Note that a standard size for the function plate is determined so that a user interfaces for setting up functions may be uniformly arranged.

The area configuration 204 and the function plate configuration 205 may be customized by editing settings using a general-purpose editor or a dedicated editor, for example.

The area switching table 206 includes information associating various modes (area modes) relating to the display of areas of a user interface with identification information of the area configuration 204 and the function plate configuration 205 to be used for generating the user interface (e.g. path information if the corresponding configurations are distinguished by files). The modes may include a mode for enlarging one or more predetermined areas, a mode for diminishing one or more predetermined areas, a mode for displaying some areas and not displaying other areas, and a mode for changing an area to be displayed, for example.

The user operation/configuration 207 may hold information relating to operations on the user interface performed by the user or settings set up by the user. The user operation/configuration 207 also includes information on a current mode (area mode).

The area arrangement unit 208 reads the area configuration 204 and generates area information describing an arrangement of areas in a predetermined format.

The display/non-display configuration unit 209 generates display configuration information for each function plate. In a case where an area for displaying a function plate is not displayed, the display/non-display configuration unit 209 generates display configuration information for not displaying the function plate.

The function plate arrangement unit 210 reads the function plate configuration 205 and generates function plate information describing an arrangement of function plates within an area in a predetermined format. When a function plate is added to an area through customization by the user, for example, the function plate arrangement unit 210 arranges the added function plate within the area according to its display order. Also, the function plate arrangement unit 210 deletes function plates that cannot be set up owing to the status or specification of the peripheral device 3 being controlled. Further, depending on whether the relevant area is designated as an area to be optimized, the function plate arrangement unit 210 may optimize the arrangement of the function plates.

The UI generation display unit 211 actually generates and displays the controls based on the area information generated by area arrangement unit 208, the function plate information generated by the function plate arrangement unit 210, and the display configuration information generated by the display/non-display configuration unit 209.

In a case where the area configuration 204 includes a plurality of area configurations and a mode change is detected, the area switching unit 212 acquires a corresponding area configuration to be used to regenerate a user interface in response to the mode change based on the association information of the area switching table 206, and prompts the UI generation display unit 211 to regenerate the user interface and display the regenerated user interface. Note that the UI generation display unit 211 may regenerate the entire user interface based on the acquired area configuration or regenerate only a portion of the user interface that includes changes, for example.

The user operation/configuration acquisition unit 213 acquires operations on the user interface performed by the user or settings set up by the user and stores the operations or settings in the user operation/configuration 207.

<Information/Data>

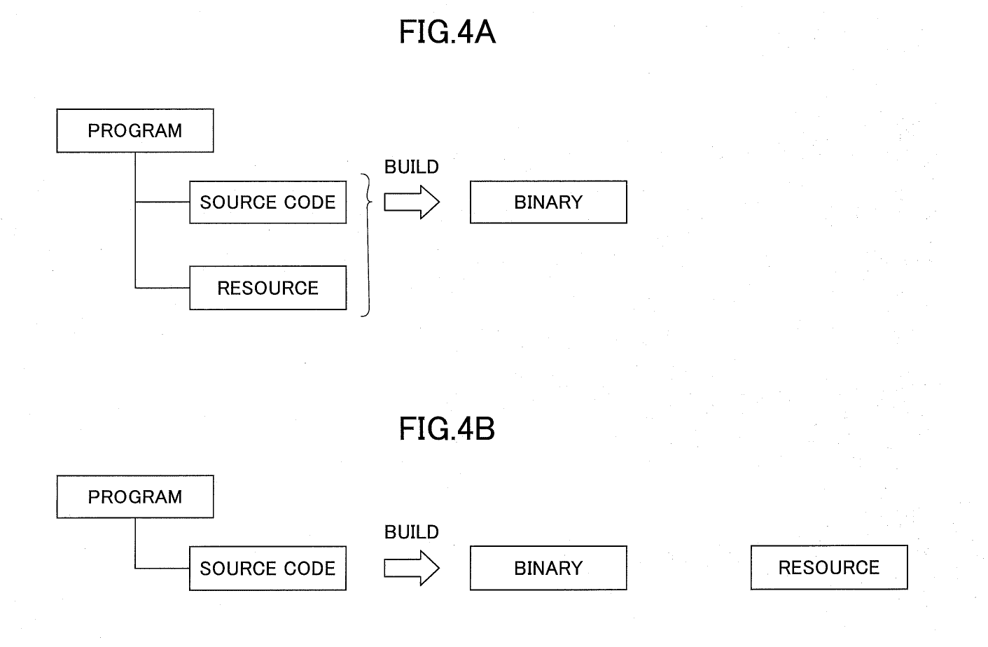

FIGS. 4A and 4B illustrate examples of creating a binary by building a program. As illustrated in FIG. 4A, a program typically includes source code describing operations to be executed and resources describing the configuration of a user interface. A binary (binary code) may be generated by building such a program (e.g. compiling the source code and linking libraries). The configuration of a user interface is expressed in binary code, and as such, resources have to be re-built even when slight customizations are made to the user interface.

The area configuration 204 and the function plate configuration 205 of the present embodiment correspond to resources in this respect. However, in the present embodiment, the area configuration 204 and the function plate configuration 205 corresponding to resources are not provided inside the program along with the source code, but are provided outside the program. That is, as illustrated in FIG. 4B, in the present embodiment, only source code corresponding to logic for generating a user interface is transformed into a binary, whereas the configuration of the user interface is described using resources that are subsequently written in text as the area configuration 204 and the function plate configuration 205. In this way, even when a user makes dynamic and real time changes to the configuration of the user interface, the program may not have to be rebuilt and a convenient user interface may be provided.

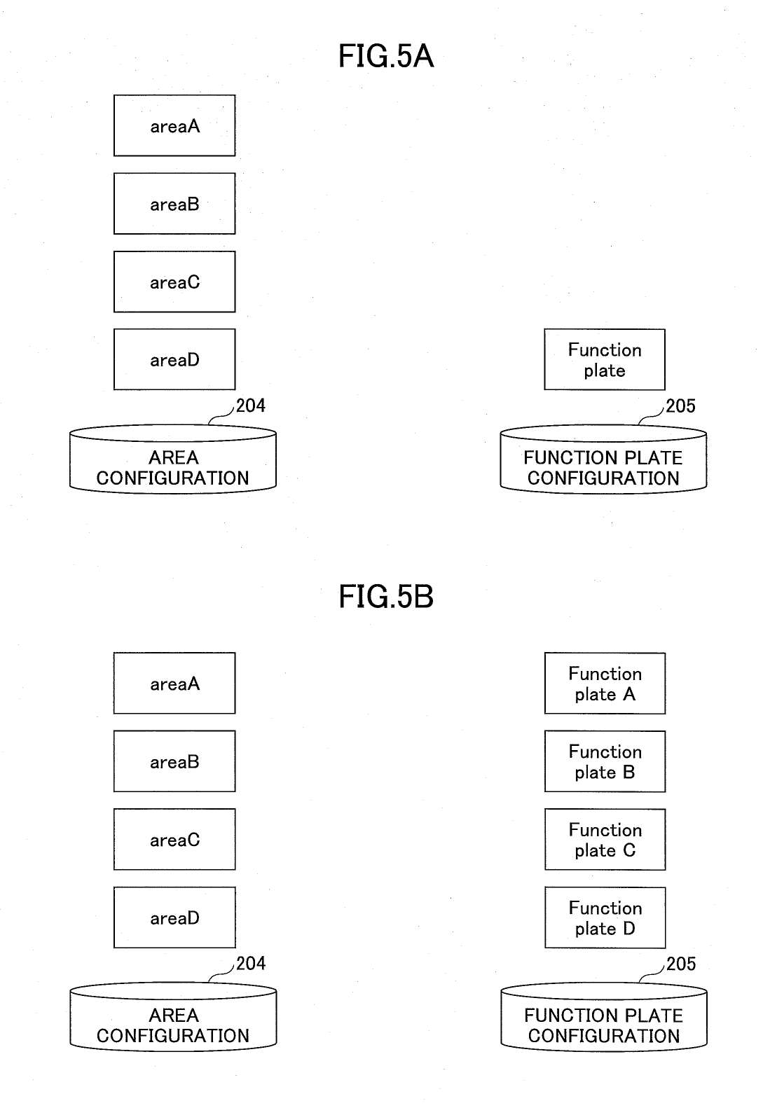

FIGS. 5A and 5B illustrate exemplary manners in which data of the area configuration 204 and the function plate configuration 205 are held. In the present example, it is assumed that four areas A-D are provided.

FIG. 5A illustrates an exemplary case in which the area configuration 204 includes separate sets of area configuration data corresponding to the areas A-D, and the function plate configuration 205 includes one set of function plate configuration data describing how function plates are to be arranged in each of the areas A-D.

FIG. 5B illustrates an exemplary case in which the area configuration 204 includes separate sets of area configuration data corresponding to the areas A-D, and the function plate configuration 205 includes separate sets of function plate configuration data corresponding to the areas A-D. That is, in the example illustrated in FIG. 5B, the function plate configuration 205 includes a number of data sets equal to the number of areas.

Note that in a case where the area configuration may be switched according to different modes, the area configuration data may include multiple subsets of data. For example, the area configuration data for area B may include a data set for a large area mode and another data set for a small area mode.

Note that in a case where the function plate configuration 205 includes only one set of function plate configuration data as illustrated in FIG. 5A, the one set of data may be utilized for multiple modes. The function plate configuration data may describe function plates to be arranged in all the areas, and the display of function plates arranged in each area may be switched between display and non-display based on the area configuration of each area. In the case where the function plate configuration 205 includes multiple sets of functional plate configuration data as illustrated in FIG. 5B, data may be separately held for each area such that visibility may be improved.

The area configuration data includes coordinate information indicating where and how an area is to be arranged on a screen. Note that one user interface may be built by preparing one set of area configuration data for each of the areas.

The function plate configuration data includes information on the functions to be arranged in a user interface, for example. Note that because a function plate is arranged within an area, the function plate cannot be arranged on a screen if its corresponding area is not arranged on the screen.

Note that although the area configuration data, and the function plate configuration data are divided into separate files in the examples of FIGS. 5A and 5B, in some embodiments, the area configuration data and the function plate configuration data may be combined into a single area file. However, for example, in a case where area A is the same (common) in all modes whereas areas B-D vary depending on the mode, instead of combining all data into a single file, configuration data relating to area A may be arranged in a separate file so that the configuration data of area A may be commonly used in the different modes to thereby improve efficiency.

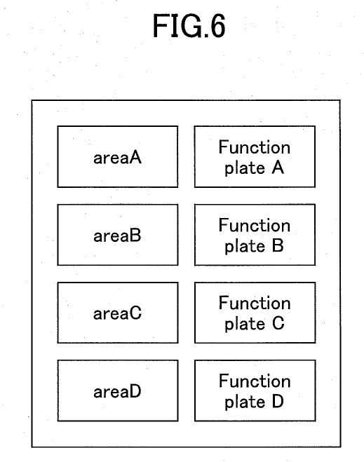

FIG. 6 illustrates an example in which data of the area configuration 204 and data of the function plate configuration 205 are arranged in a single file. As described above, separate files may be provided for a common portion that is commonly used in different area modes and a discrete portion that is only used in a certain mode, for example. Also, one file may be divided into separate sections for the area configuration and the function plate configuration, for example.

The area configuration and the function plate configuration are typically written in a format having a hierarchical structure. Examples of formats having a hierarchical structure include XML and Lua. The area configuration and the function plate configuration may be read and distinguished from one another by parsing the file including the configuration data (i.e. analyzing text written according to a formal grammar and having a complicated structure). Note that the above format and logic for reading the area configuration and the function plate configuration may be implemented not only in the case where the area configuration data and the function plate configuration data are arranged in a single file but also where the data are arranged into separate files.

In the following, examples of user interfaces and examples of the area configuration and the function plate configuration are described.

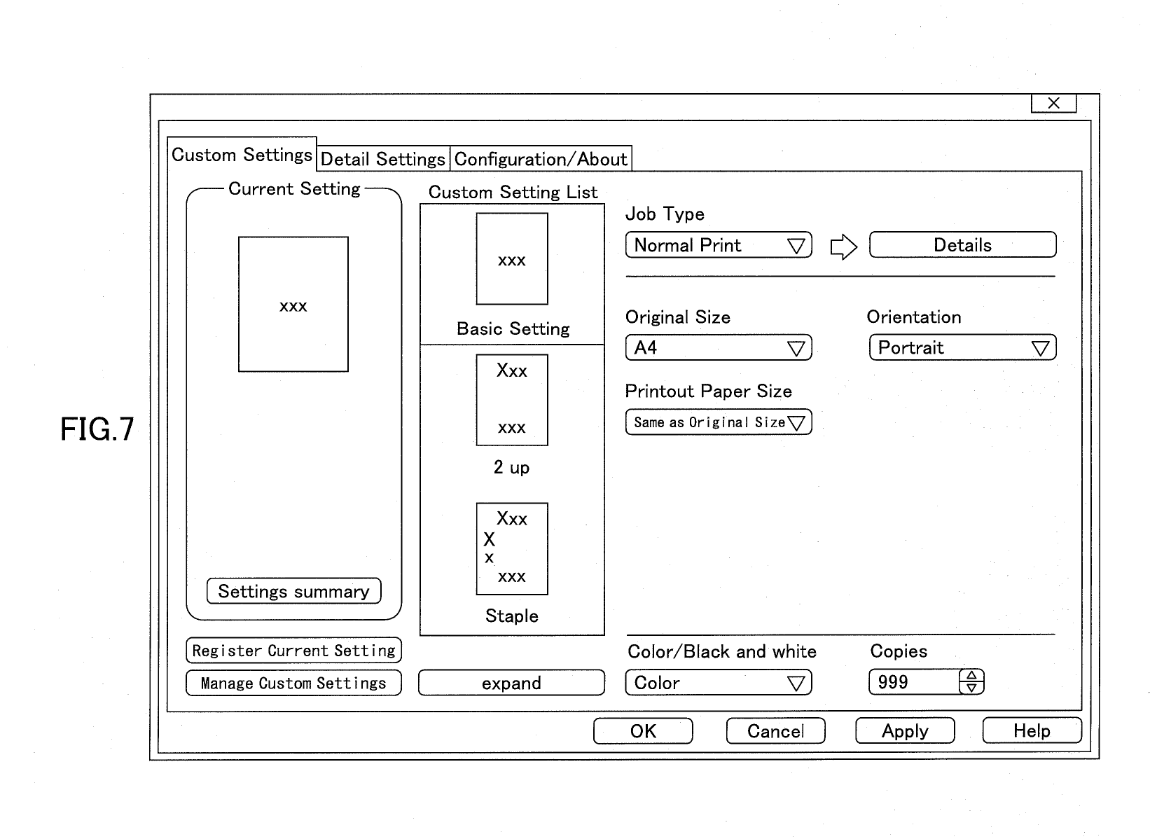

FIGS. 7-11 illustrate examples of user interface screens. The illustrated screens include a “Register Current Setting” button that enables registration of print settings such as paper size and orientation selected by a user such that the registered print settings may be repeatedly used. An icon corresponding to a setting that is once registered is displayed in a “Custom setting List” such that the same setting can be used once again by selecting the corresponding icon.

In FIG. 7, elements arranged and displayed in the “Custom Settings” tab include a “Current Setting” frame (including a “Settings summary” button), a “Register Current Setting” button, a “Manage Custom Settings” button, the “Custom Setting List”, an “expand” button, a “Job Type” list box, a “Details” button, an “Original Size” list box, an “Orientation” list box, a “Printout Paper Size” list box, a “Color/Black and white” list box, and a “Copies” button.

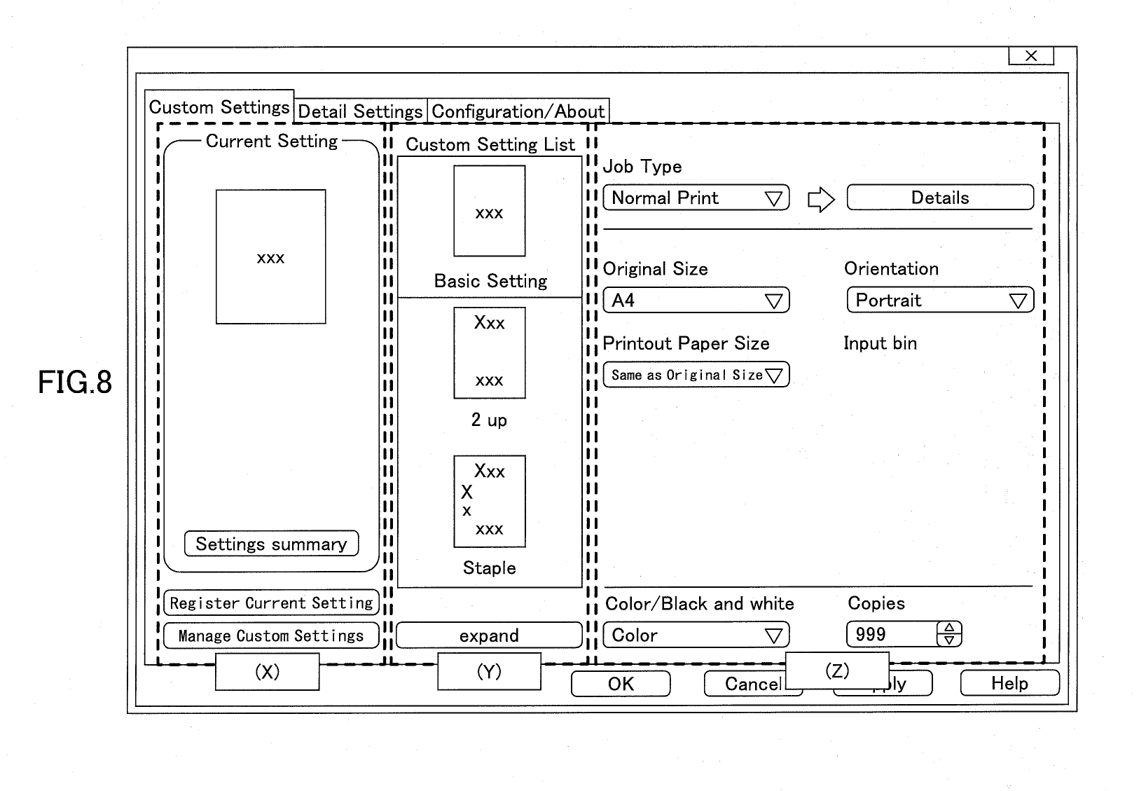

FIG. 8 illustrates perceptual regions that would normally be recognized by a user viewing the user interface of FIG. 7. As illustrated in FIG. 8, the user may recognize the “Current Setting” frame, the “Register Current Setting” button, and the “Manage Custom Settings” button as one region (region X) corresponding to a portion that indicates the current settings. Also, the user may recognize the “Custom Setting List” and the “expand” button as one region (region Y) corresponding to a portion for enabling selection of a set of settings. Further, the user may recognize the “Job Type” list box, the “Details” button, the “Original Size” list box, the “Orientation” list box, the “Printout Paper Size” list box, the “Color/Black and white” list box, and the “Copies” button as one region (region Z) corresponding to a portion that enables making changes to various print settings. In this way, the user may recognize regions according to their functional context.

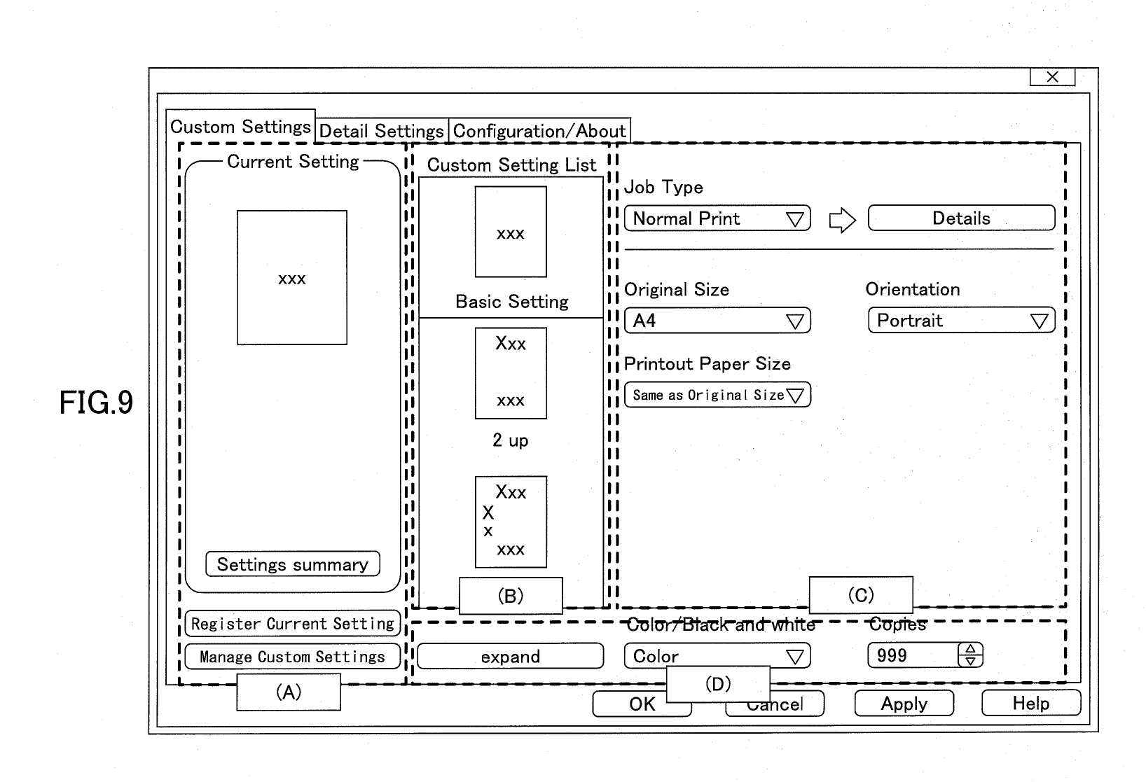

FIG. 9 illustrates an exemplary arrangement of control areas of the user interface of FIG. 7. In FIG. 9, the region X of FIG. 8 corresponds to an area A, part of the region Y of FIG. 8 including the “expand” button and part of the region Z of FIG. 8 including the “Color/Black and white” list box and the “Copies” button are cut out to form an area D. The remaining parts of the regions Y and Z correspond to areas B and C, respectively.

The “expand” button is used by the user to input an instruction for expanding the area of the “Custom Setting List” (area B). However, it is undesirable to have the position of the “expand” button shifted when the area of the “Custom Setting List” is expanded. Accordingly, the area D is arranged in view of such preference to fix the position of the “expand” button. Also, the “Color/Black and white” list box and the “Copies” button are for setting up essential print settings as opposed to other optional print settings. Thus, it is undesirable to have the positions of these buttons shifted when controls are added or deleted as a result of customization or owing to the specification of the printing device, for example. Accordingly, the area D is arranged in view of such preference to fix the positions of the “Color/Black and white” list box and the “Copies” button. On the other hand, the elements in the area C including the “Job Type” list box, the “Details” button, the “Original Size” list box, the “Orientation” list box, and the “Printout Paper Size” are preferably rearranged (optimized) to improve their overall appearance when a control is added or removed, for example.

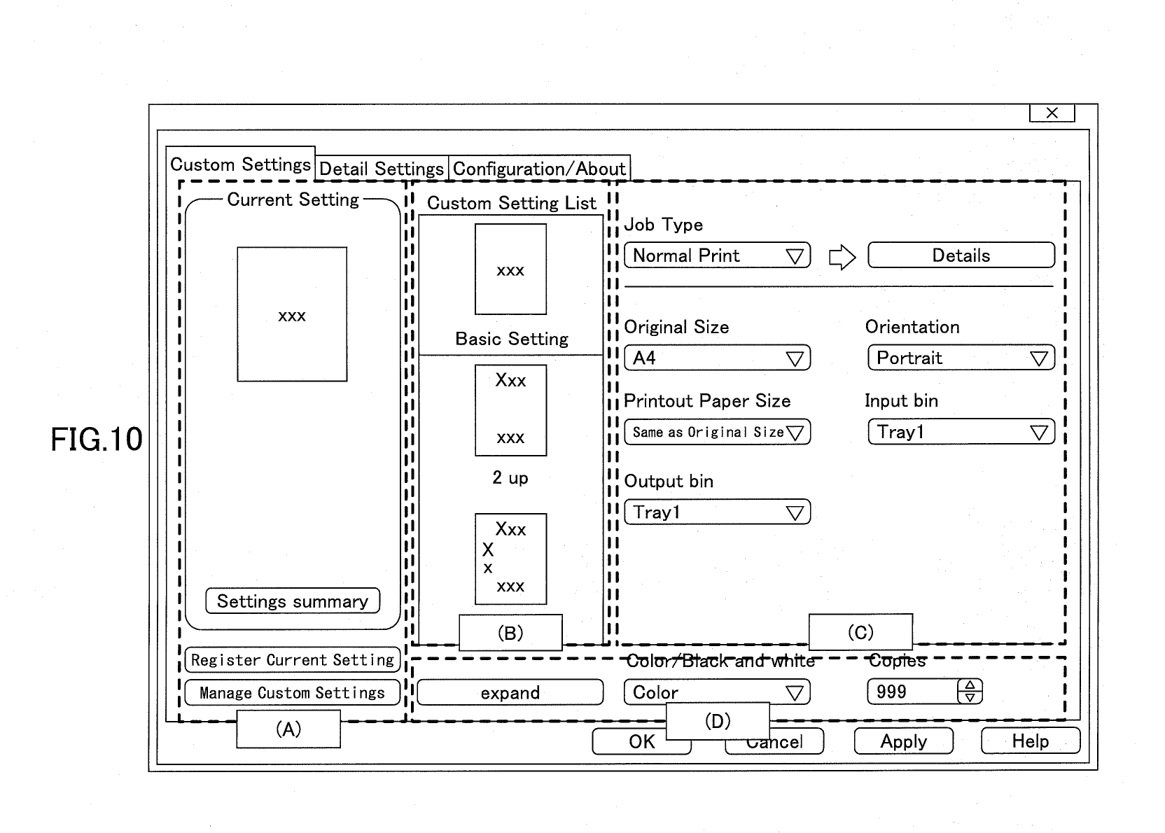

FIG. 10 illustrates an exemplary case in which an “Input bin” list box and an “Output bin” list box are added to the area C.

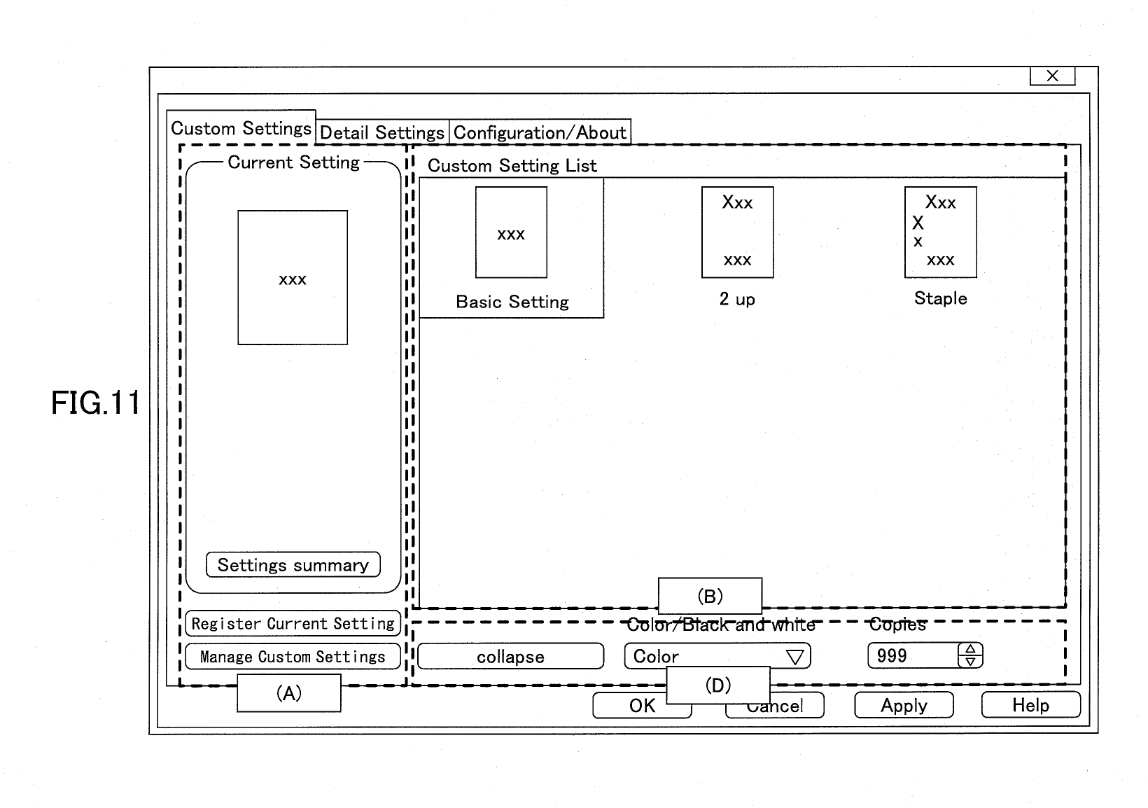

FIG. 11 illustrates an exemplary case in which the area B is expanded in response to a mode change triggered by the user operating the “expand” button included in the area D illustrated in FIG. 9 or FIG. 10. In FIG. 11, the area C is not displayed. Also, the “expand” button is replaced with a “collapse” button. By operating the “collapse” button, the mode may be changed once more and the screen may be switched back to that illustrated in FIG. 9 or FIG. 10.

Note that many users use a number of predetermined combinations of print settings most of the time and rarely use new print settings. For such users, the area C of FIG. 10 may not have to be displayed each time the user interface is displayed. Also, because the area B of FIG. 10 cannot display more than three icons, in the case of setting up more than three print settings, a scroll bar may have to be displayed and the user may have to scroll down to select an icon corresponding to the fourth and subsequent print settings. Thus, it may be burdensome for the user to set up the combination of desired print settings. In view of the above, in some embodiments, the area of the “Custom Setting List” may normally be in an expanded state as illustrated in FIG. 11 so that more icons may be displayed in the area B, and the area C for changing various print settings may be displayed only when the “collapse” button is pressed to apply new print settings, for example.

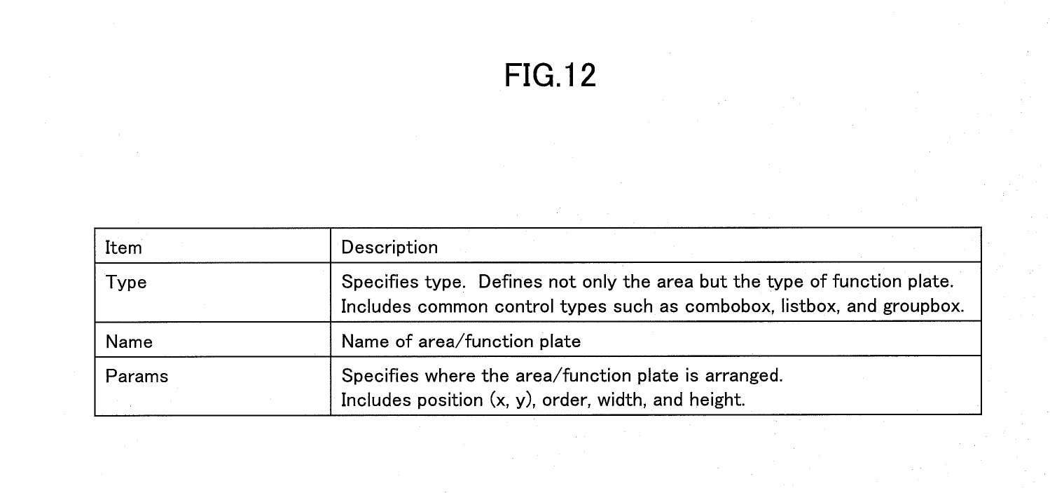

FIG. 12 is a table illustrating exemplary items describing the area configuration 204 and the function plate configuration 205.

“Type” describes the type of the object being described. This item specifies not only the area but also the type of function plate. Also, known control types such as combobox, listbox, and groupbox may be specified by this item. “Name” describes the name of an area or a function plate. “Params” describes where an area or a function plate is to be arranged and may include a position (x, y), an order, a width, and a height, for example.

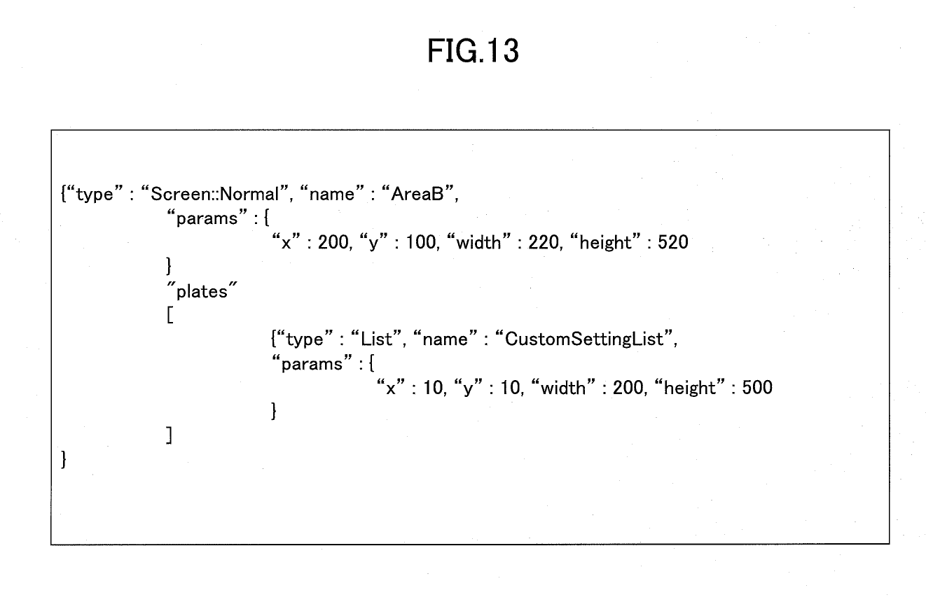

FIG. 13 illustrates a specific example of data describing the area configuration and the function plate configuration of the area B illustrated in FIG. 9. In FIG. 13, the first through fourth lines describe the area configuration and the lines from the fifth line and onward describe the function plate configuration. The first line (“type”: “Screen::Normal”, “name”: “AreaB”) indicates that the type of the object being described is an area where optimization is not performed (“Screen::Normal” represents an area that is not rearranged even when a function plate is removed; and “Screen::Normalize” represents an area that is automatically rearranged when a function plate is removed) and that the name of the area is “AreaB” (area B). The third line indicates the position of the area. The seventh line (“type”: “List”, “name”: “CustomSettingList”) indicates that the type of object being described is a list (control attribute) and that the name of the list is “CustomSettingList”. The ninth line indicates the position of the function plate.

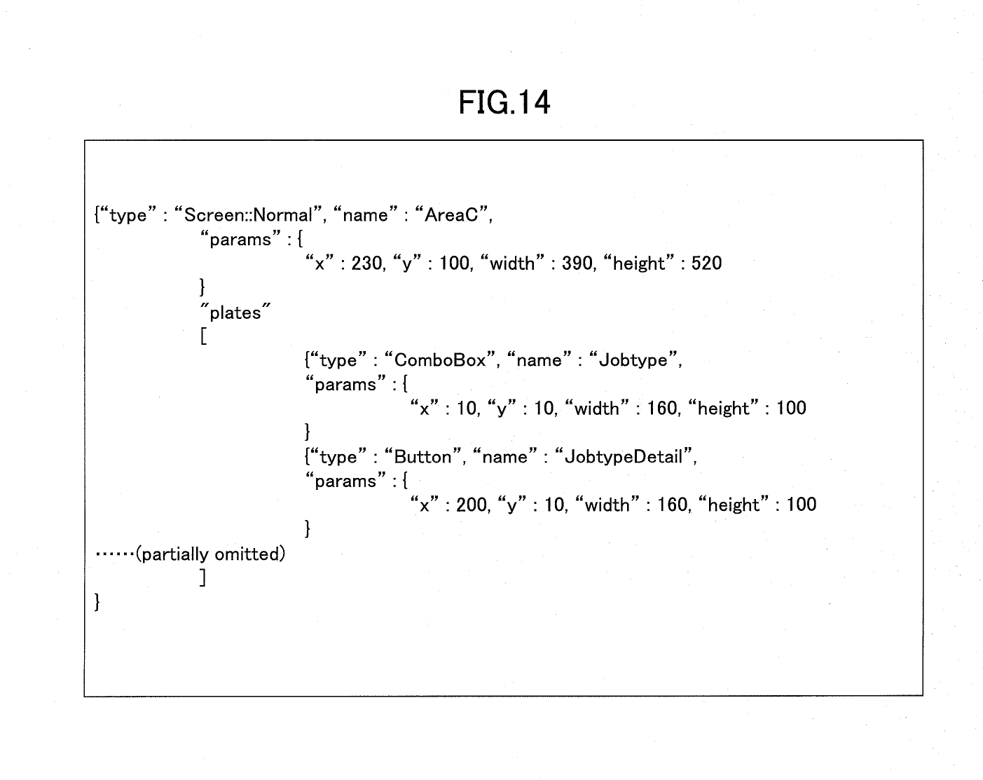

FIG. 14 illustrates a specific example of data describing the area configuration and the function plate configuration of the area C illustrated in FIG. 9. In FIG. 14, the first through fourth lines describe the area configuration and the lines from the fifth line and onward describe the function plate configuration.

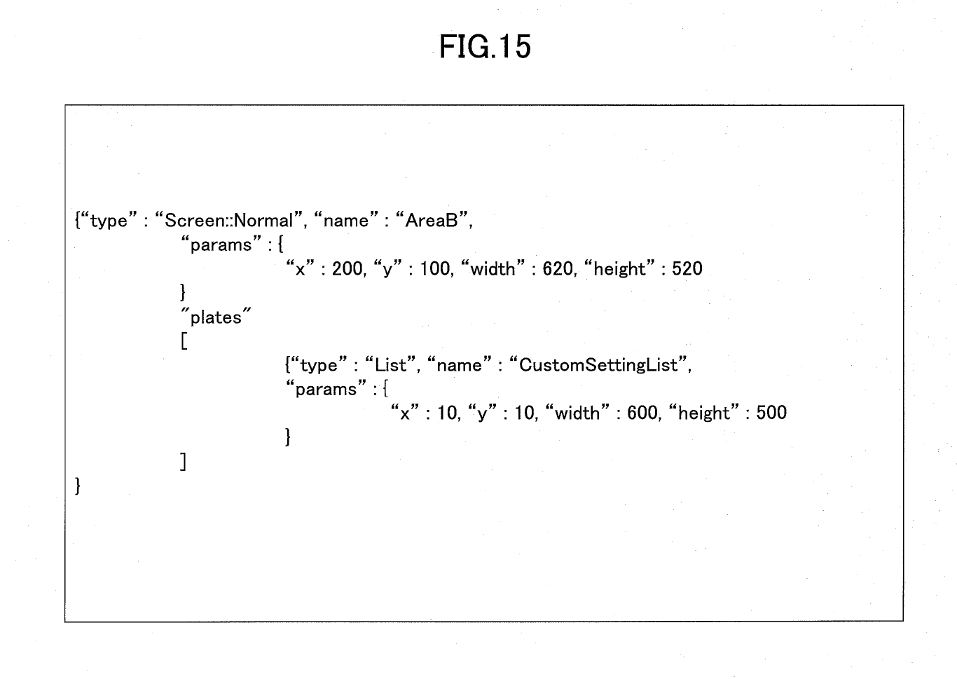

FIG. 15 illustrates a specific example of data describing the area configuration and the function plate configuration of the area B illustrated in FIG. 11. In FIG. 15, the first through fourth lines describe the area configuration and the lines from the fifth line and onward describe the function plate configuration. Note that the configuration data illustrated in FIG. 13 and the configuration data illustrated in FIG. 15 both describe configurations of the area B. The configuration data of FIG. 13 may be used in default mode (small area mode), and the configuration data of FIG. 15 may be used when the mode is changed to a large area mode in response to the user operating the “expand” button, for example. Further, the configuration data of FIG. 13 may be used when the mode is switched back to small area mode in response to the user operating the “collapse” button, for example.

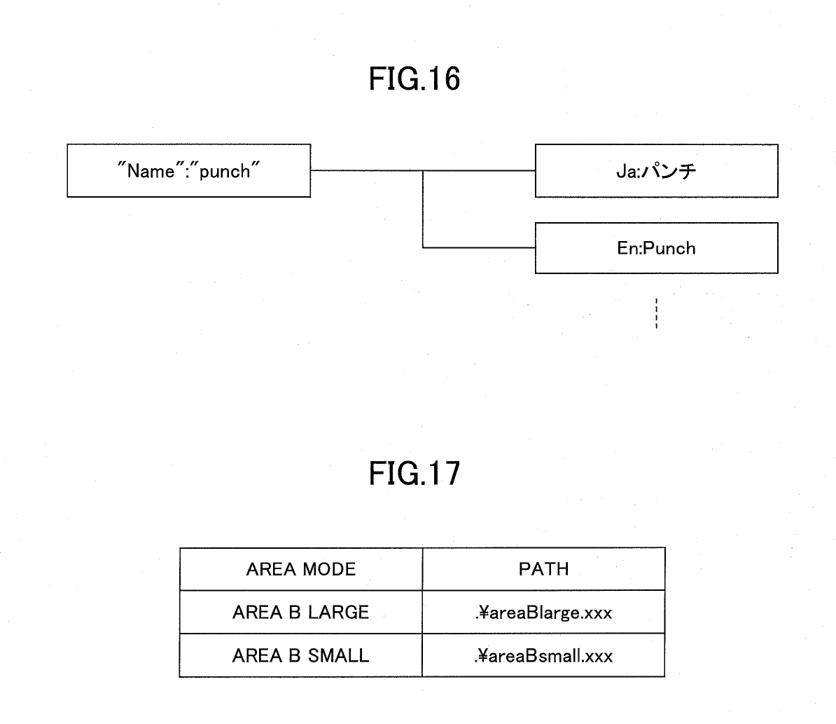

Note that the “name” may also be used as an ID for obtaining a label to be displayed on the actual control. For example, assuming the name is “punch” (“Name”: “punch”) and a corresponding label is “ [symbol] ” in Japanese and “Punch” in English, the name “punch” may be used as an ID to search a language file as illustrated in FIG. 16 to find the section indicated as “Name”: “punch” and obtain the corresponding label in the desired language that is to be displayed on the actual control.

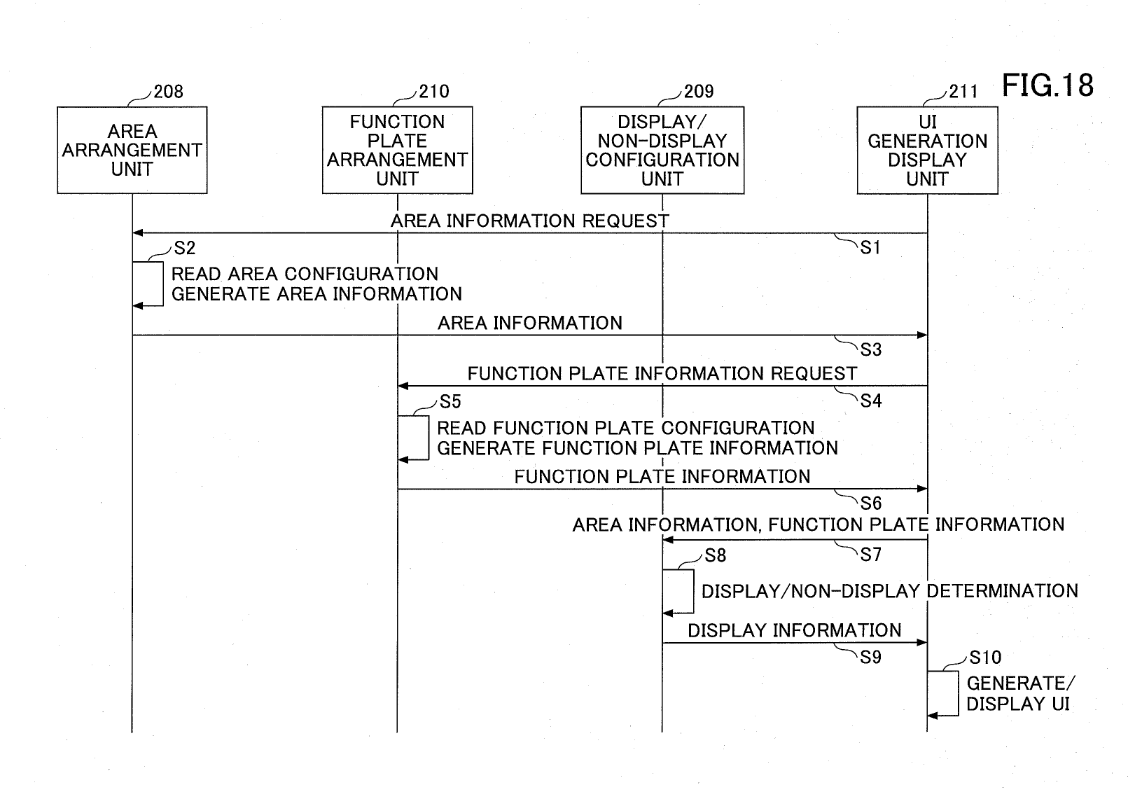

FIG. 17 illustrates an example of the area switching table 206. The area switching table 206 of FIG. 17 associates an area mode with a path (file path) of the configuration file to be referenced when the corresponding area mode is implemented.

<Operations>

FIG. 18 is a sequence chart illustrating exemplary process steps that may be executed when the printer driver 203 receives a user interface display request.

In FIG. 18, the UI generation display unit 211 sends an area information request to the area arrangement unit 208 (step S1).

In turn, the area arrangement unit 208 reads the area configuration 204 to generate area information describing an arrangement of an area in a predetermined format (step S2), and sends a response including the generated area information to the UI generation display unit 211 corresponding to the sender of the area information request (step S3).

Then, the UI generation display unit 211 sends a function plate information request to the function plate arrangement unit 210 (step S4).

In turn, the function plate arrangement unit 210 reads the function plate configuration 205 to generate function plate information describing an arrangement of a function plate within an area in a predetermined format (step S5), and sends a response including the generated function plate information to the UI generation display unit 211 (step S6).

Then, the UI generation display unit 211 passes the area information and the function plate information to the display/non-display configuration unit 209 and requests the display/non-display configuration unit 209 to make a display/non-display determination (step S7).

In turn, the display/non-display configuration unit 209 makes a display/non-display determination to generate display configuration information indicating the display/non-display determination result (step S8), and sends a response including the generated display configuration information to the UI generation display unit 211 (step S9).

Then, the UI generation display unit 211 generates a user interface based on the area information, the function plate information, and the display configuration information, and displays the generated user interface (step S10).

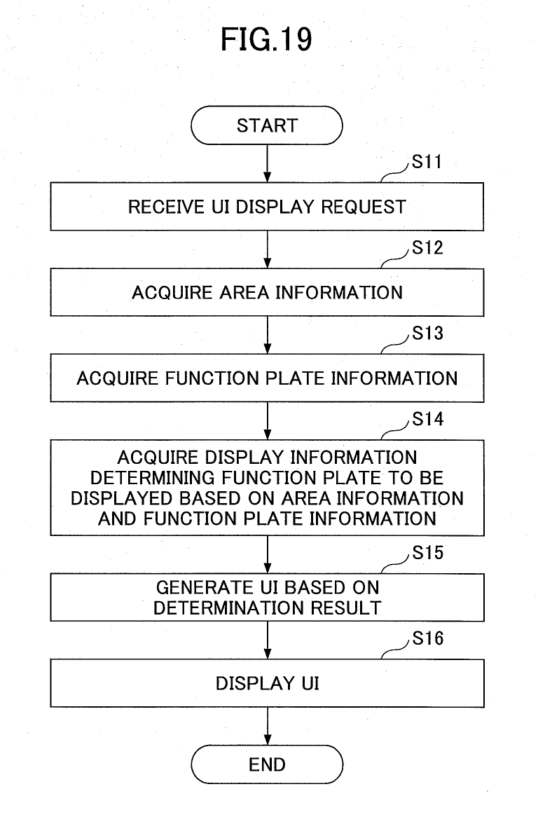

FIG. 19 is a flowchart illustrating exemplary process operations of the UI generation display unit 211 when the process of FIG. 18 is executed.

In FIG. 19, when the UI generation display unit 211 receives a user interface display request (step S11), the UI generation display unit 211 sends a request for area information to the area arrangement unit 208 to acquire the area information (step S12), and sends a request for function plate information to the function plate arrangement unit 210 to acquire the function plate information (step S13).

Then, the UI generation display unit 211 sends a request for display configuration information to the display/non-display determination unit to acquire the display configuration information determining the function plate to be displayed (step S14).

Then, the UI generation display unit 211 generates a user interface based on the display configuration information indicating the display/non-display determination result (step S15) and displays the generated user interface (step S16).

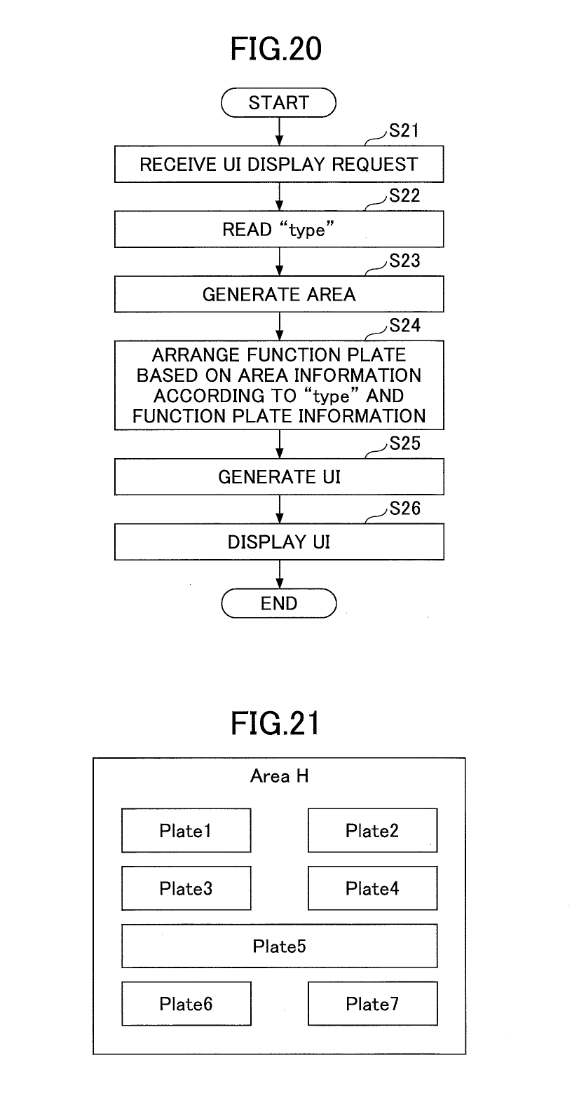

FIG. 20 is a flowchart illustrating exemplary process operations that may be executed by the UI generation display unit 211 instead of the process operations illustrated in FIG. 19. Note that the process operations of FIG. 20 are specifically for cases in which the area configuration and the function plate configuration are described in a format having a hierarchical structure such as the examples of FIGS. 13-15.

In FIG. 20, when the UI generation display unit 211 receives a user interface display request (step S21), the UI generation display unit 211 prompts the area arrangement unit 208 to read the “type” of the area configuration and the function plate configuration (step S22) and prompts the area arrangement unit 208 to generate an area (step S23).

Then, the UI generation display unit 211 prompts the function plate arrangement unit 210 to arrange function plates based on the area information and the function plate information according to the “type” (step S24).

Then, the UI generation display unit 211 generates a user interface (step S25) and displays the generated user interface (step S26).

In the following, function plate arrangement operations of the function plate arrangement unit 210 (step S5 of FIG. 18) are described in greater detail.

As described above, FIG. 10 illustrates a case where function plates are added to the area C illustrated in FIG. 9. That is, the “Input bin” list box and the “Output bin” list box are added to the area C illustrated in FIG. 10.

When a function plate is removed, the display within the area C may be optimized accordingly (e.g. by adjusting the spacing of the function plates). That is, based on predetermined rules, the function plate arrangement unit 210 may determine whether the appearance of the corresponding area may be improved by moving the function plates and rearrange the function plates based on the determination result. Note that although the user may perceive the “Color/Black and white” list box and the “Copies” button as function plates belonging to the area C, these function plates belong to the area D and therefore do not move into the area C.

By allocating the function plates to multiple areas as described above, the positions of certain function plates may be fixed while the positions of certain other function plates may be optimized, for example. That is, by configuring function plates that are desirably fixed and function plates that are desirably optimized into separate areas, a flexible arrangement of the function plates may be enabled, for example.

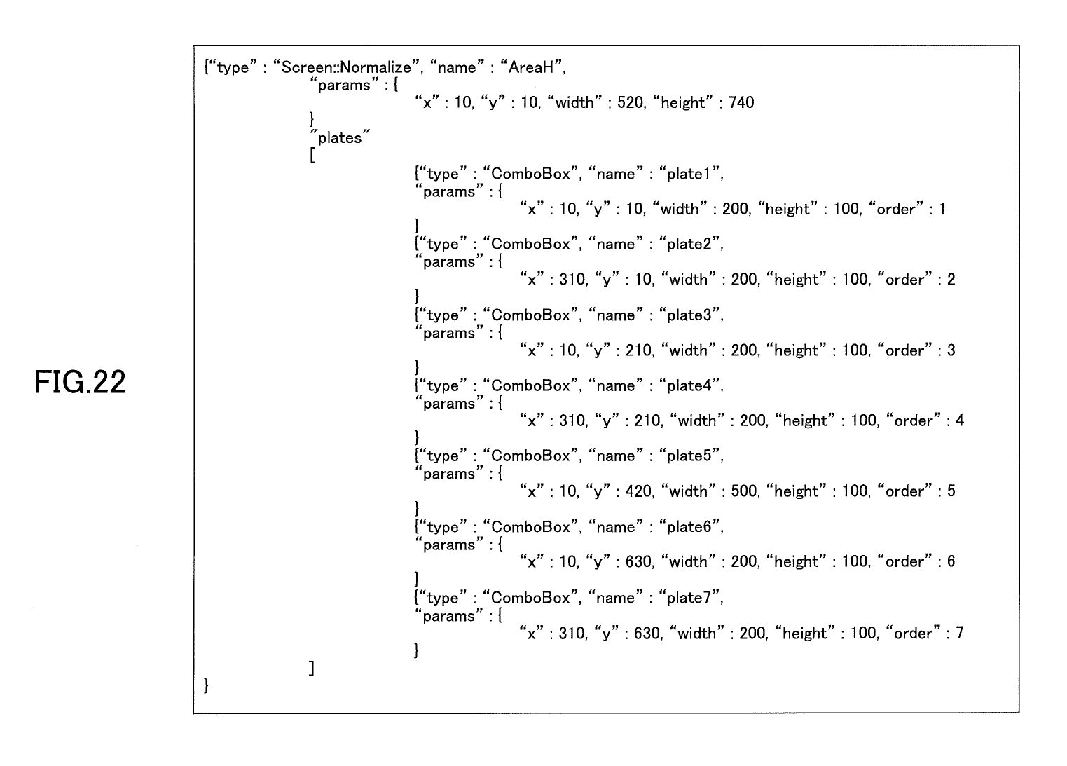

In the following, exemplary process operations for optimizing the positions of function plates (controls) by adjusting the spacing of the function plates are described with reference to FIGS. 21 and 22. FIG. 21 illustrates an exemplary arrangement of function plates within an area H. FIG. 22 illustrates exemplary data describing the area configuration and the function plate configuration of the area H. Note that in this example, the area H includes plates 1-7 as function plates. Also, the area H corresponds to an area to be optimized as indicated in the first line of FIG. 22 (“Screen::Normalize”).

In this case, the function plate arrangement unit 210 arranges the function plates from the upper left side according to their display order based on the value of the “order” described in the “params” of each function plate and according to the “width” and “height” of the function plates. For example, in a case where the second function plate (plate 2) is a control for setting up a punch function (“Punch”) and the peripheral device 3 does not include a finisher such that the punch function cannot be used, the second function plate (plate 2) has to be removed because this function plate cannot be used.

When the second function plate is removed, a space is created between the first plate (plate 1) and the third plate (plate 3) and user convenience may be compromised as a result. Accordingly, in the present example, the third plate (plate 3) is moved up to the position where the second plate (plate 2) was originally located. Similarly, the fourth plate (plate 4) is moved up to the position where the third plate was originally located. However, the display of a function plate having a long width such as the fifth plate (plate 5) may be cut off if it is placed at the position where the fourth function plate (plate 4) was originally located. This can be determined based on the width of the area H and the width and x-coordinate value of plate 5. Accordingly, when it is determined that a function plate cannot be moved based on a comparison of the width and height of the function plate and the width and height of a location to which the function plate is to be moved, the function plate is not moved.

In the present example, when the second function plate is removed, the third function plate and the fourth function plate are respectively moved up to where the second function plate and the third function plate were originally located, but the fifth function plate is not moved. Because the function plates have to be displayed according to their display order, when the fifth function plate is not moved, the sixth function plate and subsequent function plates are not moved either.

In the following, the display/non-display determination by the display/non-display configuration unit 209 (e.g. step S8 of FIG. 18) are described in greater detail.

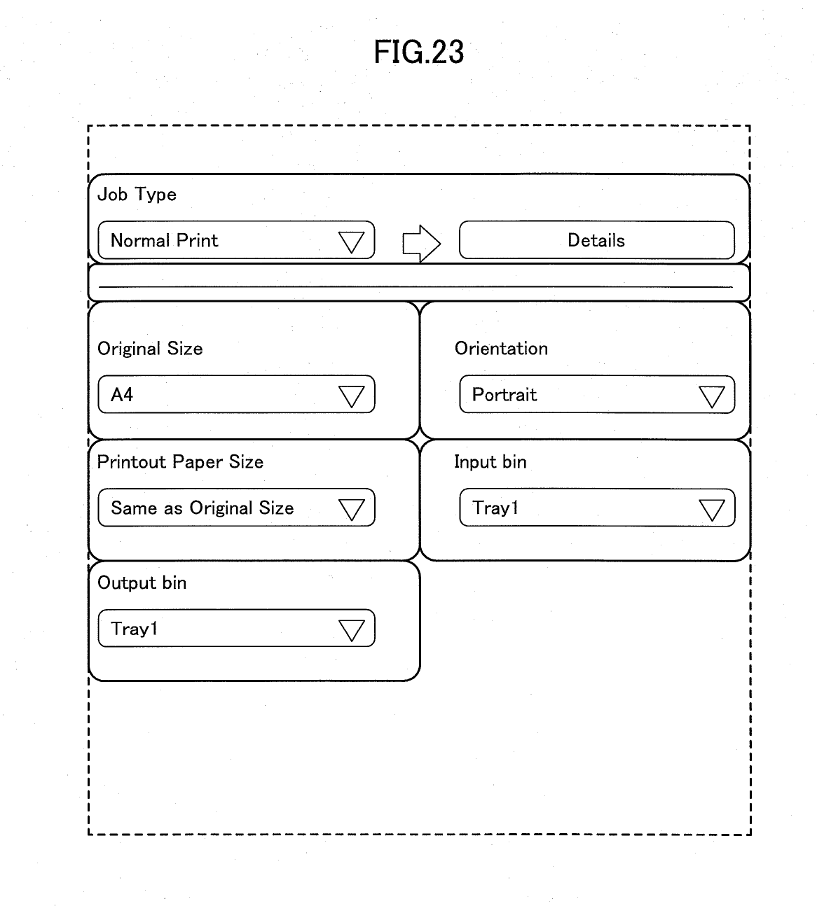

FIG. 23 illustrates a relationship between an area and functional plates. In FIG. 23, an area is indicated by a dashed line, and function plates indicated by solid lines are arranged on the area. If the area is to be displayed, it is determined that the function plates arranged on the area are to be displayed as well. If the area is not to be displayed, it is determined that the function plates arranged on the area are not to be displayed. That is, the display/non-display determination may be made based on the inclusion of the function plates in the area, and therefore, case-by-case analyses depending on whether the area is displayed or not displayed may be unnecessary.

In the following, process operations by the area switching unit 212 are described.

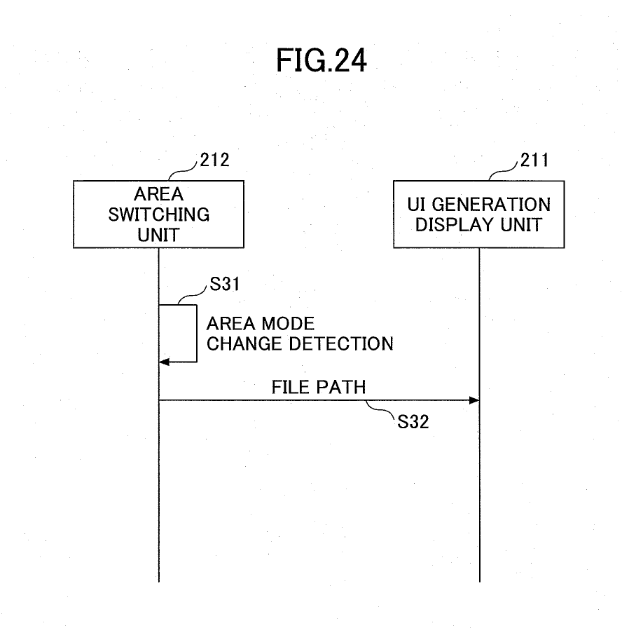

FIG. 24 is a sequence chart illustrating exemplary process steps that may be executed in response to a mode change.

In FIG. 24, when the area switching unit 212 detects that an area mode has been changed (step S31), the area switching unit 212 refers to the area switching table 206, acquires the file paths for the area configuration and the function plate configuration to be used, notifies the UI generation display unit 211 of the file paths, and starts a user interface regeneration/display process (step S32).

The UI generation display unit 211 receiving the notification of the file paths performs the process steps illustrated in FIGS. 18-20 once again to regenerate a user interface and display the regenerated user interface. Note that the UI generation display unit 211 may regenerate the entire use interface based on new settings or regenerate only a portion of the user interface that has to be changed, for example.

As described above in connection with FIG. 9, when the “expand” button included in the area D is pressed, the area mode is changed from “area B small” (default) to “area B large”. By detecting the mode change, the user interface may be regenerated and displayed in real time based on the configuration files designated by the new file paths. FIG. 11 illustrates a case where the area B is expanded to take up the space of the area C.

The area arrangement unit 208 determines the position and size of the area B and lays out the area B accordingly. Note that because the area C is no longer displayed, the function plates arranged on the area C are not displayed. As a result of expanding the area B, the contents of the “Custom Setting List” included in the area B may be displayed across a wider area.

When the “collapse” button included in the area D of FIG. 11 is pressed, the area mode is changed from “area B large” to “area B small”, and the screen display is reverted back to that illustrated in FIG. 9.

According to an aspect of the present embodiment, the area display mode as illustrated in FIG. 11 may be used with respect to a user that only uses the “Custom Setting List” of the area B so that visibility and usability of the user interface may be improved. On the other hand, with respect to a user that uses not only the “Custom Setting List” of the area B but also the function plates included in the area C, the area display mode as illustrated in FIG. 9 may be used to enable use of the “Custom Setting List” as well as the controls for changing print settings included in the area C. That is, the present embodiment is capable of accommodating two types of user requests.

Note that in the case where the “expand” button and the “collapse” button are used as in the above-described embodiment, the area mode may only be switched between two modes for displaying the screen as illustrated in FIG. 9 and the screen as illustrated in FIG. 11, for example. However, in other embodiments, a combobox may be used to enable switching between three or more types of area configurations, for example.

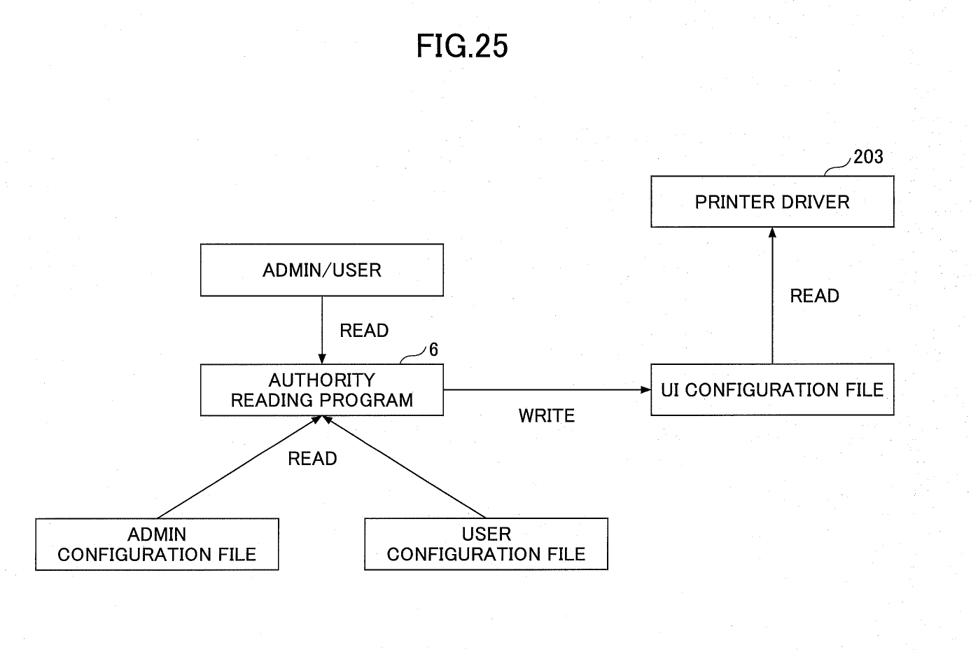

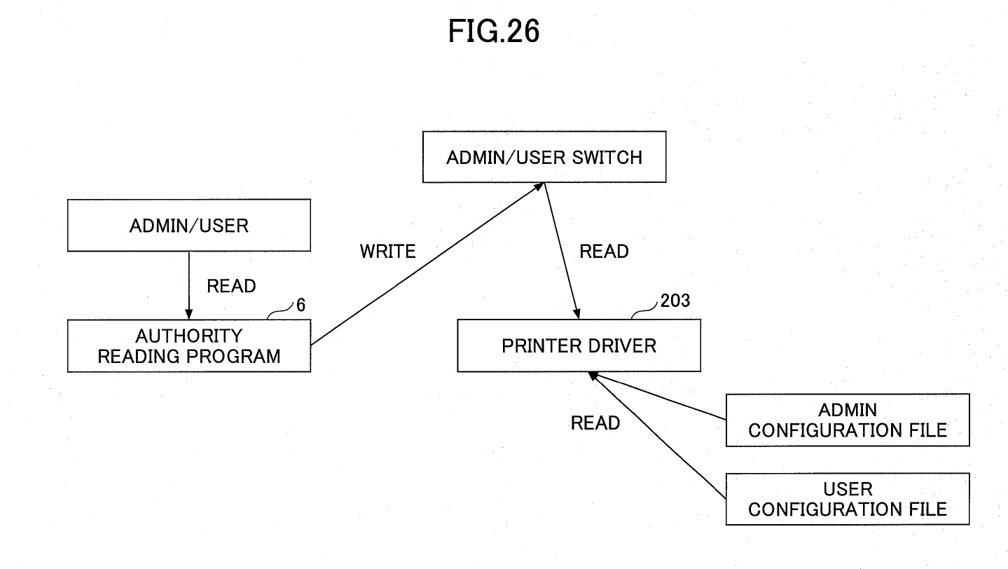

In the following, examples of switching user interfaces using external files are described with reference to FIGS. 25 and 26. Specifically, the examples described below relate to methods of providing two types of user interfaces to accommodate the specific needs of an administrator (admin) and a general user (user).

Administrators and general users have different objectives with respect to a printer driver. For example, from the standpoint of reducing TCO (total cost of ownership), administrators may wish to encourage users to use black and white printing because black and white printing is generally cheaper than color printing. Further, administrators may wish to encourage users to use functions such as double side printing and combining. On the other hand, general users often do not pay attention to print settings and may wish to be able to easily select the print settings set up by the administrator rather than selecting detailed settings themselves. In view of the above, in the present embodiment, areas are configured to enable switching between two types of user interfaces and optimizing the arrangement of functions. A first user interface of the two user interfaces may be configured to enable detailed setup of the printer driver to enable administrators to easily set up print settings such as black and white printing, double side printing, and combining, for example. A second user interface of the two user interfaces may omit screens displaying detailed print settings to enable users to easily select print settings set up by the administrators and enable designation of such print settings in one step, for example.

In a case where an IT (information technology) administrator wishes to have users select only essential functions in order to reduce the TCO, the IT (information technology) administrator may wish to switch configuration files according to the user, for example. As described above in connection with FIG. 4B, resources of a user interface may be held as configuration files outside a program without being complied. In this case, the configuration files may be exchanged.

In FIG. 25, when a user logs in, an authority reading program 6 determines whether the user is logging in under authority of an administrator or a general user (admin/user). Note that separate user interface configuration files are provided for administrators and general users. For example, the user interface for administrators may enable the selection of color printing, whereas the user interface for general users may not even include a setting screen for selecting such print setting.

The authority reading program 6 reads a corresponding configuration file based on its determination of the user authority and writes the corresponding configuration file as a UI configuration file. Each time a user interface is to be built, the printer driver 203 reads the UI configuration file, generates a user interface based on the read UI configuration file, and displays the generated user interface.

In FIG. 26, when a user logs in, the authority reading program 6 determines whether the user is logging under authority of an administrator or a general user (admin/user). Then, the authority reading program 6 writes the determination result as admin/user switch information.

Each time a user interface is to be built, the printer driver 203 reads the admin/user switch information, reads the corresponding configuration file, generates a user interface based on the read configuration file, and displays the generated user interface.

In the following, an example in which the area configuration and the function plate configuration are provided outside the printer driver is described.

Printer drivers include the so-called “Point and Print” function that may be used in a server/client environment. For example, the Point and Print function may be used in the case of using a queue (mechanism for storing print jobs that have been generated) of a printer driver of a server at the client side. In this case, the Point and Print function copies only information inside the printer driver of the server to the client side. Accordingly, a mechanism is needed for enabling use of an area configuration file and a function plate configuration file provided outside the printer driver.

That is, because the Point and Print function is a mechanism for synchronizing a specific file and a registry identified as the printer driver at the server side with the client side, an external file (area configuration file, function plate configuration file) that is not provided within the printer driver may not be carried over to the client side by simply using the Point and Print function. As a result, the user interface may not be dynamically switched at the client side. Therefore, a special mechanism is desired at the client side.

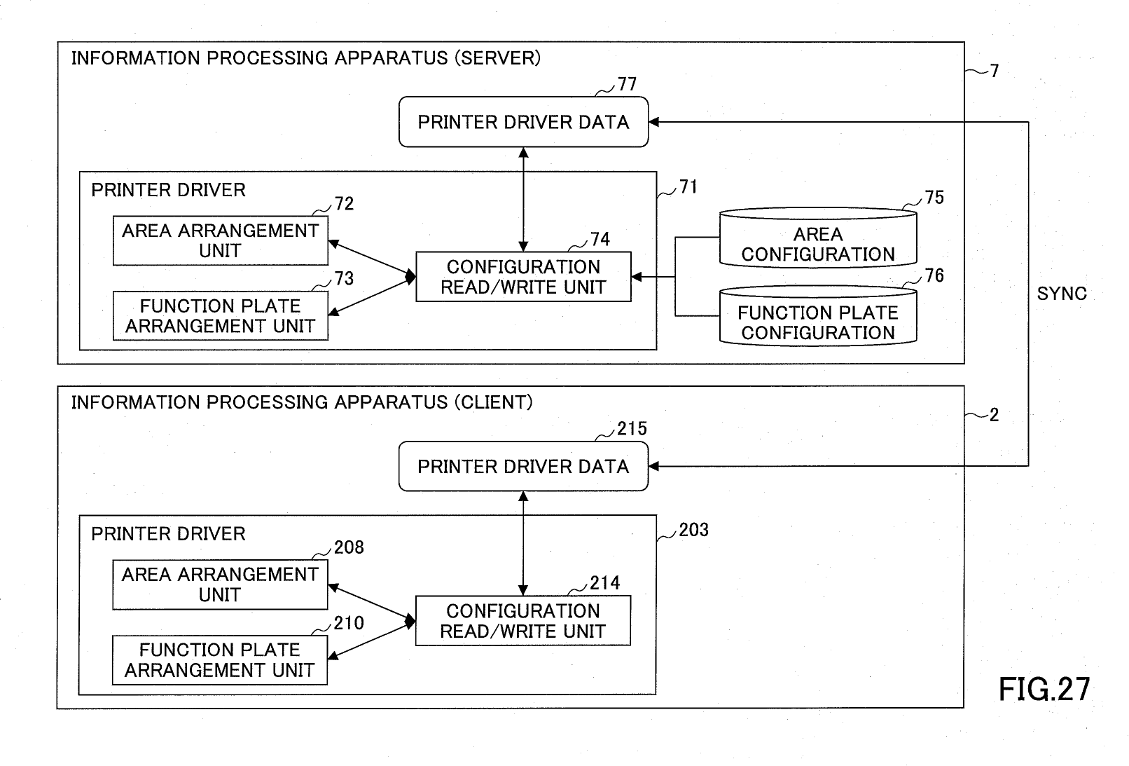

FIG. 27 is a block diagram illustrating an exemplary system configuration for applying the Point and Print function. In FIG. 27, a printer driver 71 of a server side information processing apparatus 7 includes an area arrangement unit 72, a function plate arrangement unit 73, and a configuration read/write unit 74. The area arrangement unit 72 and the function plate arrangement unit 73 substantially correspond to the area arrangement unit 208 and the function plate arrangement unit 210 of FIG. 3. At the server side information processing apparatus 7, an area configuration 75 and a function plate configuration 76 are provided outside the printer driver 71. The area configuration 75 and the function plate configuration 76 substantially correspond to the area configuration 204 and the function plate configuration 205 area of FIG. 3. The configuration read/write unit 74 of the printer driver 71 is configured to read the area configuration 75 and the function plate configuration 76 and write the read configuration data in a printer driver data 77, which is a part of the registry of an OS of the information processing apparatus 7.

Also, the printer driver 203 of the information processing apparatus 2 at the client side includes a configuration read/write unit 214 in addition to the area arrangement unit 208 and the function plate arrangement unit 210. Note that the area configuration 204 and the function plate configuration 205 are not held at the client side. When configuration data is written in a printer driver data 215 of the registry of the OS 202, the configuration read/write unit 214 of the printer driver 203 reads the configuration data. When configuration data is not written in the printer driver data 215 or the configuration read/write unit 214 is explicitly instructed to read some other area configuration and function plate configuration, the configuration read/write unit 214 reads and writes configuration data as instructed. The configuration read/write unit 214 may be implemented by adding a function of reading an external file in response to an explicit instruction to the device properties of the printer driver 203, for example.

The printer driver data 77 at the server side and the printer driver data 215 at the client side are synchronized by the Point and Print function. The configuration read/write unit 74 at the server side reads the area configuration 75 and the function plate configuration 76 and writes the read configuration data in the printer driver data 77 of the registry of the OS such that the contents of the printer driver data 77 may be synchronized with the printer driver data 215 at the client side. The configuration read/write unit 214 at the client side reads the contents of the printer driver data 215, and the area arrangement unit 208 and the function plate arrangement unit 210 respectively perform area arrangement and function plate arrangement according to the configuration data read by the configuration read/write unit 214. In this way, the user interface configuration data held outside the printer driver may be read and the user interface may be dynamically switched.

### SUMMARY

As described above, according to an aspect of the present embodiment, by allowing a plurality of areas to be arranged for a group of setting objects, customization of each area may be enabled, and the arrangement of multiple setting objects within one area may be dynamically switched in real time to thereby improve user convenience.

Although the present invention has been described above with reference to certain illustrative embodiments, the present invention is not limited to these embodiments, and numerous variations and modifications may be made without departing from the scope of the present invention.

Note that the user operation/configuration acquisition unit 213 of FIG. 3 is an exemplary embodiment of a receiving unit configured to receive a screen display instruction according to the present invention.

The area configuration 204 of FIG. 3 is an exemplary embodiment of an area information storage unit configured to store area information relating to a plurality of areas of the screen according to the present invention. The information content of the area configuration 204 corresponds to an exemplary embodiment of area information according to the present invention.

The function plate configuration 205 of FIG. 3 is an exemplary embodiment of a display information storage unit configured to store display information associated with each of the plurality of areas according to the present invention. The information content of the function plate configuration corresponds to an exemplary embodiment of display information according to the present invention.

The UI generation display unit 211 of FIG. 3 is an exemplary embodiment of a display unit configured to display the screen based on the area information stored in the area information storage unit and the display information stored in the display information storage unit according to the present invention.

The area switching table 206 of FIG. 3 is an exemplary embodiment of an association information storage unit configured to store a display switching instruction in association with corresponding area information of the area information stored in the area information storage unit according to the present invention.

The area switching unit 212 of FIG. 3 is an exemplary embodiment of an acquisition unit configured to acquire the corresponding area information associated with the display switching instruction based on the association information when the display switching instruction is accepted via the screen displayed by the display unit according to the present invention.

The UI generation display unit 211 of FIG. 3 is also an exemplary embodiment of a display control unit configured to switch display of the screen based on the corresponding area information acquired by the acquisition unit according to the present invention.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device. The non-transitory storage medium can comprise any computer-readable medium except for a transitory, propagating signal.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Application No. 2013-192241 filed on Sep. 17, 2013, and Japanese Patent Application No. 2014-153608 filed on Jul. 29, 2014, the entire contents of which are hereby incorporated by reference.

What is claimed is:

1. An information processing program product comprising a non-transitory computer-readable medium having a program recorded thereon that is executable by a computer, the program when executed causing the computer to implement functions of:
a receiving unit configured to receive a screen display instruction to display a screen for accepting an instruction;
an area information storage unit configured to store area information relating to a plurality of areas of the screen, the area information storage unit storing at least one set of area information for each of the plurality of areas;
a display information storage unit configured to store display information associated with each of the plurality of areas;
a display unit configured to display the screen based on the area information stored in the area information storage unit and the display information stored in the display information storage unit;
an association information storage unit configured to store a display switching instruction in association with corresponding area information of the area information stored in the area information storage unit;
an acquisition unit configured to acquire the corresponding area information associated with the display switching instruction based on the association information when the display switching instruction is accepted via the screen displayed by the display unit; and
a display control unit configured to switch display of the screen based on the corresponding area information acquired by the acquisition unit.

2. The information processing program product as claimed in claim 1, wherein the area information and the display information are held as resources outside a program.

3. The information processing program product as claimed in claim 1, wherein the area information and the display information include a common portion that is commonly used by a plurality of user interfaces and a discrete portion that is used by a predetermined user interface of the plurality of user interfaces.

4. The information processing program product as claimed in claim 1, wherein the program causes the computer to implement a function of making a determination relating to display of the screen based on the area information and the display information.

5. The information processing program product as claimed in claim 1, wherein the program causes the computer to implement a function of optimizing a display arrangement for at least one area of the plurality of areas of the screen.

6. The information processing program product as claimed in claim 1, wherein the program causes the computer to implement a function of starting regeneration of a user interface in response to a mode change, the user interface being regenerated based on the area information and the display information for each of the plurality of areas of the screen associated with a corresponding mode.

7. An information processing apparatus comprising:
a receiving unit configured to receive a screen display instruction to display a screen for accepting an instruction;
an area information storage unit configured to store area information relating to a plurality of areas of the screen, the area information storage unit storing at least one set of area information for each of the plurality of areas;
a display information storage unit configured to store display information associated with each of the plurality of areas;
a display unit configured to display the screen based on the area information stored in the area information storage unit and the display information stored in the display information storage unit;
an association information storage unit configured to store a display switching instruction in association with corresponding area information of the area information stored in the area information storage unit;
an acquisition unit configured to acquire the corresponding area information associated with the display switching instruction based on the association information when the display switching instruction is accepted via the screen displayed by the display unit; and
a display control unit configured to switch display of the screen based on the corresponding area information acquired by the acquisition unit.

8. An information processing system comprising:
a receiving unit configured to receive a screen display instruction to display a screen for accepting an instruction;
an area information storage unit configured to store area information relating to a plurality of areas of the screen, the area information storage unit storing at least one set of area information for each of the plurality of areas;
a display information storage unit configured to store display information associated with each of the plurality of areas;
a display unit configured to display the screen based on the area information stored in the area information storage unit and the display information stored in the display information storage unit;
an association information storage unit configured to store a display switching instruction in association with corresponding area information of the area information stored in the area information storage unit;
an acquisition unit configured to acquire the corresponding area information associated with the display switching instruction based on the association information when the display switching instruction is accepted via the screen displayed by the display unit; and
a display control unit configured to switch display of the screen based on the corresponding area information acquired by the acquisition unit.
